(19) United States
(12) Patent Application Publication
(10) Pub. No.: US 2008/0283664 A1
(43) Pub. Date: Nov. 20, 2008

(54) Aircraft Fuselage Structure

(76) Inventor: Hal Errikos Calamvokis, London (GB)

Correspondence Address: WORKMAN NYDEGGER, 60 EAST SOUTH TEMPLE, 1000 EAGLE GATE TOWER, SALT LAKE CITY, UT, 84111, US

(21) Appl. No.: 12/091,277

(22) PCT Filed: Oct. 19, 2006
(86) PCT No.: PCT/GB2006/003883

§ 371 Date: May 15, 2008

(30) Foreign Application Priority Data
Oct. 27, 2005 (GB) 0521928.2

(51) Int. Cl. B64C 1/00

(52) U.S. Cl. 244/119

(57) ABSTRACT

An aircraft fuselage shell section comprises a skin (11) defining a boundary between a first air pressure and a second air pressure, and a reinforcing structure (13) connected to the skin (11). The skin and reinforcing structure are adapted to bear, in use, pressure load resulting from a pressure differential between the first and second air pressures, the second pressure being substantially lower than the first. The reinforcing structure is disposed on the side of the boundary having the second air pressure such that the aircraft fuselage shell section has an “exoskeleton” construction whereby the pressure load forces the skin and reinforcing structure together.

### FIELD OF THE INVENTION

The present invention relates to an aircraft fuselage shell section, in particular the structure of such a section.

### BACKGROUND TO THE INVENTION

The very first aircraft fuselages comprised wooden truss structures and wire braces for stressing the trusses. As engine power, and thus aircraft speeds, increased it became necessary to provide an aerodynamic surface external to the truss structure to give occupants protection from airflow. The aerodynamic surface (such as doped canvas) was typically stretched over the truss structure. The aerodynamic surface also had the effect of reducing aerodynamic drag.

In the 1920s as metal structures became commonplace in aircraft design it was realised that a monocoque structure, whereby the aerodynamic surface was also a load-bearing part of the fuselage structure, was more efficient and almost all aircraft fuselages have been constructed in this way ever since.

As passenger aircraft flew higher and faster the fuselage had to be pressurised, to avoid the occupants continuously wearing oxygen masks—this meant that the primary work of the aerodynamic surface was now to contain the pressurisation forces. The advent of jet passenger travel mandated covering the fuselage structure with comprehensive insulation, as the external temperature at cruising altitude is normally below −50° C.

Construction of current jet aircraft fuselage structures has not changed since the 1950s which typically comprise a shell including an outer load-bearing skin, an outer surface of which forms the aerodynamic surface, having a reinforcing structure attached thereto. The reinforcing structure generally comprises stiffening members (stringers) extending between transverse members (frames) which prevent the skin from buckling under load. The skin is typically fastened to the reinforcing structure by rivets. The shell is capable of withstanding an internal pressure load such that the aircraft may be pressurized to an internal pressure higher than that external to the aircraft. The skin forms a pressure hull and carries most of the hoop stresses generated by the internal pressure and transmits them to the frames.

A major drawback of this type of construction is that at altitude the pressurisation forces are continuously trying to rip the skin from the reinforcing structure, requiring thousands of the rivets to keep the shell structure together, which increases construction costs as well as aircraft weight. In addition, the complex shape of the reinforcing structure (frames and stringers) makes it difficult to effectively insulate.

In addition, since in conventional aircraft fuselage shell structures the load-bearing skin is in direct contact with ambient air (i.e. air external to the aircraft at altitude temperature and pressure), the skin is likely to reach sub-zero temperatures during aircraft cruise. There is a known problem in that internal pressurized air condenses and freezes on the skin of such conventional structures as a result of the sub-zero skin temperatures. The initial freezing can crack composite structures, or significant corrosion of metal structures (including aluminium) can occur upon thaw.

It is therefore an object of the present invention to provide an aircraft fuselage shell section capable of withstanding internal pressure, requiring fewer parts and being easier to manufacture than previously, with due consideration to weight implications, and which is less susceptible to freeze-thaw damage.

### SUMMARY OF THE INVENTION

According to a first aspect of the present invention, an aircraft fuselage shell section comprises:
a skin defining a boundary between a first air pressure and a second air pressure; and
a reinforcing structure connected to the skin,
wherein:
the skin and reinforcing structure are adapted to bear, in use, pressure load resulting from a pressure differential between the first and second air pressures, the second pressure being substantially lower than the first; and
the reinforcing structure is disposed on the side of the boundary having the second air pressure.

The first aspect of the invention is advantageous in that aircraft pressurization forces actually force the skin and the reinforcing structure together, not apart. This allows a much simpler, and therefore lighter, form of connection than the many rivets conventionally required.

The aircraft fuselage section preferably further comprises a second skin connected to the reinforcing structure and disposed from the skin. The second skin may constitute, or support, an aerodynamic surface of the section.

A space formed between the skin and the aerodynamic surface may be filled, with insulating material such that the aerodynamic surface is thermally decoupled from the skin as much as possible. By this construction moist pressurized air internal to the shell section is far less susceptible to condensing on the skin than is the case with conventional shell structures. The insulating material is preferably also load-bearing. The insulation material may be easily installed since it may either be constructed out of a rigid insulation and given the same shape as the reinforcing structure or may be blown or allowed to expand between the skin and the aerodynamic surface.

To insulate the load-bearing skin such that condensation is not readily formed thereon may increase the weight of insulating material when compared with traditional Mylar blanket insulation. However, weight saving may be achieved by a reduction in fuel required for heating the internal pressurized air, and also the lack of ice being transported. In addition, weight saving of the shell structure may be achieved by a reduction in the weight of fasteners/fastening material for fastening the load-bearing skin to the reinforcing structure and a reduction in the weight of the reinforcing structure.

According to a second aspect of the present invention, an aircraft fuselage shell section comprises:
a first skin defining a first boundary between a first air pressure and a second air pressure;
a second skin defining a second boundary between a third air pressure and the second air pressure;
a first reinforcing structure connected to the first skin; and
a second reinforcing structure connected to the second skin;
wherein:
the first skin and its reinforcing structure and the second skin and its reinforcing structure are adapted to bear, in use, pressure load resulting from a pressure differential between the first and third air pressures;
the third air pressure is substantially lower than the first air pressure; and
the first and second reinforcing structures are disposed on the side of the respective boundaries having the second air pressure.

The second aspect of the invention is advantageous in that aircraft pressurization forces may actually force the first skin and its reinforcing structure together, similar to the first aspect, but also in that both the first and second skins and their reinforcing structures support the pressure load in a ratio dependent on the first, second and third pressures forming a lightweight, strong structure.

### BRIEF DESCRIPTION OF THE DRAWINGS

Examples of the present invention will now be described in detail with reference to the drawings, in which:

FIG. 1 is a cross-section view of a conventional aircraft fuselage shell section;

FIG. 2 is a perspective view of a wire frame representation of a conventional aircraft fuselage shell section;

FIG. 3 is a cross-section view of an aircraft fuselage shell section in accordance with a first embodiment of the present invention;

FIG. 4 is a perspective view of a wire frame representation of an aircraft fuselage shell section in accordance with the first embodiment of the present invention;

FIG. 5 is a cross-section view of an alternative insulation arrangement for the aircraft fuselage shell section of FIG. 3;

FIG. 6 is a cross-section view of an aircraft fuselage shell section in accordance with a second embodiment of the present invention;

FIG. 7 is a cross-section view of an aircraft fuselage shell section in accordance with a third embodiment of the present invention;

FIG. 8 is a cross-section view of an aircraft fuselage shell section in accordance with a fourth embodiment of the present invention;

FIG. 9 is a cross-section view of an aircraft fuselage shell section in accordance with a fifth embodiment of the present invention;

FIG. 9a is a cross-section view of a joint taken along line A-A of FIG. 9;

FIG. 10 is a cross-section view of an aircraft fuselage shell section in accordance with a sixth embodiment of the present invention;

FIG. 10a is a cross-section view of a joint taken along line B-B of FIG. 10; and

FIG. 10b is a cross-section view of a joint taken along line C-C of FIG. 10.

### DETAILED DESCRIPTION

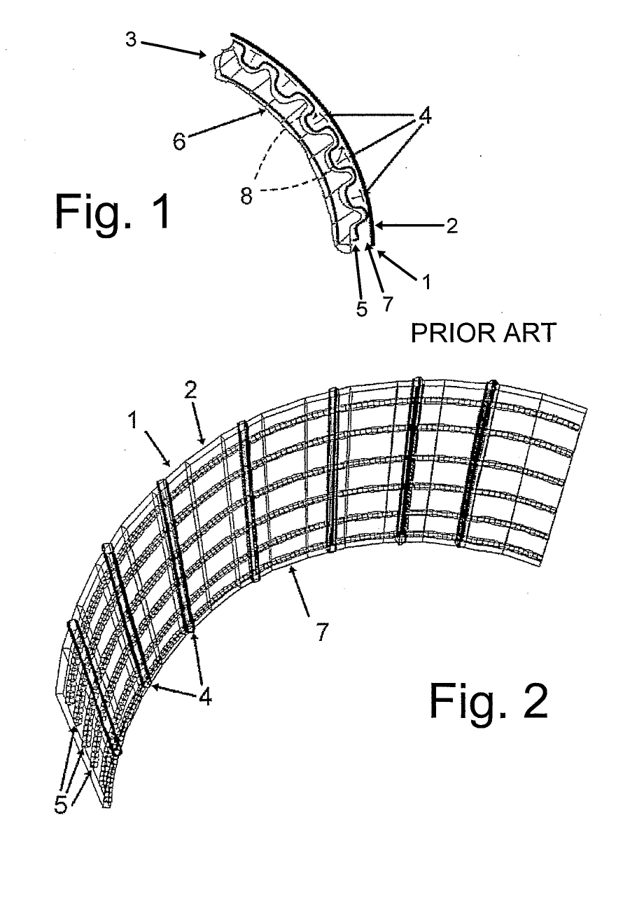

A conventional aircraft fuselage shell section is shown in detail in FIG. 1. The section comprises a skin 1, an outer surface of which constitutes a smooth aerodynamic surface 2 of the section, and a reinforcing structure 3. The reinforcing structure 3 is connected to the skin 1 and includes longitudinal stringers 4 and transverse frames 5. Only one frame 5 is shown in the cross-section of FIG. 1. Insulation material 6 is disposed over and between the frames 5 to thermally insulate the skin 1, the aerodynamic surface of which contacts the ambient air outside of the aircraft, from the aircraft cabin air. The insulation material 6 covers both the stringers 4 and the frames 5. A Mylar blanket is conventionally used as the insulation material 6.

Conventionally, the skin 1, stringers 4 and frames 5 are of aluminum for its combination of strength and low density. In such a construction, these components are generally formed separately and riveted together with a large number of rivets, which add significantly to the overall weight of the section. The aircraft cabin air of commercial aircraft is typically pressurized to well above ambient pressure in the cruise and so the pressure loading on the aircraft fuselage shell is significant. Accordingly, the number of rivets required is significantly dependent on the pressure differential.

It has recently been proposed to use carbon-fibre for the skin 1 and stringers 4 for a large commercial airliner, the stringers 4 being integrally formed with the skin 1 in a single lay-up and cure. Any cut-outs required (for windows, doors etc) will then be made and the frames 5 and cut-out reinforcements applied. The use of carbon-fibre rather than aluminum is expected to give significant weight saving since both the strength-to-weight ratio of carbon fibre is higher than for aluminum but also since the stringers will be integrally formed with the skin to the exclusion of rivets there. However, this proposed carbon-fibre integral structure is not different in basic construction to that shown in FIG. 1 and both types of construction will be referred to as “conventional” hereafter.

Some fixtures and fittings of conventional aircraft cabins are generally secured to the fuselage frames 5. Cabin panelling is typically of plastics material which is not sealed. Accordingly, cabin air is permitted to circulate around, or through, the insulation material 6 and so can contact an interior surface 7 of the skin 1. The passage of cabin air from the cabin to the interior skin surface 7 is shown by arrows 8.

In the cruise, the temperature of the skin 1 can be sub-zero, up to around −50° C. Moist cabin air that contacts the interior skin surface 7 is therefore likely to condense and freeze almost instantaneously. Even if the cabin air is largely prevented from contacting the interior skin surface 7, moisture in the cabin air is likely to condense upon contact with the insulation material 6. When the insulation material 6 becomes saturated with moisture this condensation can then drip back into the cabin environment. Where the interior skin surface 7 is of carbon-fibre, freeze damage to the carbon-fibre may occur if the moisture is able to penetrate into the carbon-fibre. Where the interior skin surface 7 is of metal, even aluminum, the acidity of the frozen condensate when it thaws as the aircraft descends from the cruise causes serious corrosion issues at the surface 7.

The perspective representation of part of the conventional aircraft fuselage shell section is shown in FIG. 2. The representation only shows the skin 1, stringers 4 and frames 5. The stringers 4 and frames 5 are disposed on an interior side of the skin 1 and connected to the interior surface 7 of the skin 1.

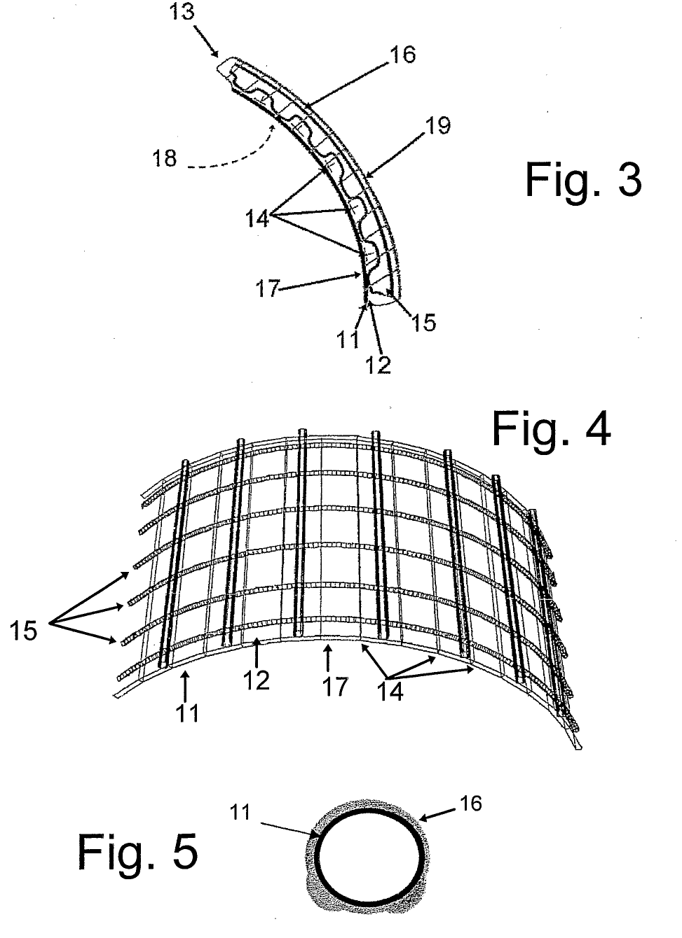

A first embodiment of the present invention will now be described with reference to FIG. 3. In the cross-section view of the aircraft fuselage shell section of FIG. 3 a skin 11 forms a boundary between aircraft cabin air and ambient aircraft air external to the aircraft, similar to the conventional skin 1 of FIGS. 1 and 2. The skin has an interior surface 17 on the side of the boundary nearest the aircraft cabin air and an exterior surface 12 on the side of the boundary nearest the ambient aircraft air. During aircraft cruise the aircraft cabin air is likely to be at a considerably higher pressure than the ambient aircraft air.

The skin 11 has a reinforcing structure 13 connected to the skin 11 and of stringers 14 and frames 15 for reinforcing the skin 11, similar to the conventional reinforcing structure 3 of FIGS. 1 and 2. In the first embodiment of the present invention, however, the reinforcing structure 13 is disposed on the side of the boundary having the ambient aircraft air pressure. That is, the reinforcing structure 13 is connected to the exterior surface 12 of the skin 11. In this manner, as the aircraft fuselage is pressurized such that the aircraft cabin air has a higher pressure than the ambient aircraft air, the pressure forces tend to force the skin 11 and its reinforcing structure 13 together, rather an apart as is the case for conventional fuselage sections such as shown in FIGS. 1 and 2. As a result, the connection itself between the reinforcing structure 13 and the skin 11 does not have to resist the pressure loading. The connection between the reinforcing structure 13 and the skin 11 need only be capable of resisting loading other than the pressure loading caused by the fuselage pressurization, as the pressure loading can now be transmitted between the skin 11 and the frames 15. As a result, the maximum forces on the connection are reduced when compared with conventional fuselage structures and so the connection can be adapted to resist relatively reduced loading thus achieving a weight saving. The benefits of weight saving in aircraft structures are many and well known.

In order to provide a smooth aerodynamic surface for the aircraft fuselage, the section of FIG. 3 has a second skin 19, the outer surface of which forms the smooth aerodynamic surface. The second skin 19 is connected to the reinforcing structure 13 and is disposed from the skin 11. Insulation material 16 is built up onto the reinforcing structure 13 between the skin 11 and the aerodynamic surface. The insulation material may itself form part of the second skin 19, or a separate second skin 19 may be provided in addition to the insulating material 16. The insulation material may be load bearing depending on the application. Where a separate second skin is provided, this may be painted to provide decorative possibilities for the fuselage section.

The “exoskeleton” construction of the fuselage section in accordance with the first embodiment of the present invention provides further advantages. Since insulation material 16 is provided between the aerodynamic surface which is in direct contact with the ambient aircraft air external to the aircraft and the skin 11, the skin 11 becomes thermally decoupled from the aerodynamic surface. Accordingly, circulating cabin air (as shown by arrow 18) cannot contact regions of the fuselage section at sub-zero temperatures. The freezing and/or freeze-thaw problems associated with conventional aircraft fuselages are thereby overcome. This advantage is similarly important in both aluminum and carbon-fibre material type fuselage sections. For both types the weight saving gained by not carry large quantities of ice around the world is evident. In addition, corrosion resistance for aluminium types and resistance to cracking through freeze-thaw for carbon-fibre types is of great benefit for aircraft proprietors. The retention of moisture in the cabin air, previously lost to ice, will also improve passenger comfort.

In contrast to the conventional aircraft fuselage shell section shown in FIG. 2, FIG. 4 shows a perspective representation of part of the fuselage section in accordance with the first embodiment of the present invention. The representation only shows the skin 11, stringers 14 and frames 15. The stringers 14 and frames 15 are disposed on an exterior side of the skin 11 and connected to an exterior surface 12 of the skin 11.

The skin 11 may be of aluminium, titanium or glass or carbon fibre, or indeed any other suitable material. Similarly, the reinforcing structure 13 may be of aluminium, titanium or glass or carbon fibre, or any other suitable material. The reinforcing structure 13 may be riveted, welded or glued to the skin 11 by known manufacturing processes. At least a part of the reinforcing structure 13 may be integrally formed with the skin 11, particularly the stringers 14.

The aircraft fuselage shell section in accordance with the first embodiment of the present invention may have an alternative insulation arrangement to that shown in FIG. 3. Rather than the uniform thickness of insulation material 16 shown in FIG. 3, the thickness of the insulation material 16 may be adapted to give more protection to the fuselage from any ground impacts, as shown in FIG. 5. The most vulnerable parts of the fuselage (namely the lower ‘corners’) may have an increased thickness of insulation material 16.

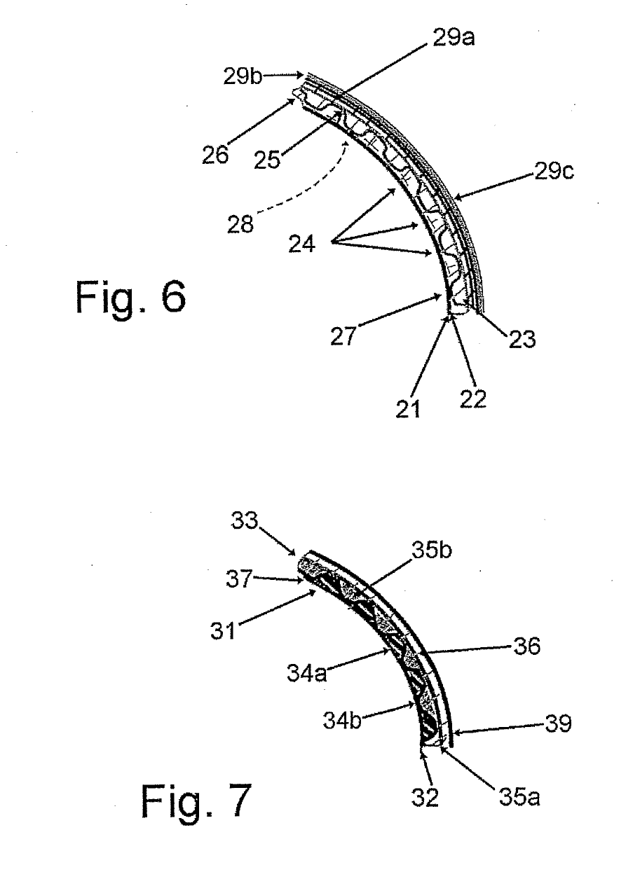

Next, a second embodiment of the present invention will be described with reference to FIG. 6. The second embodiment is similar in many respects to the first embodiment of the present invention. In the cross-section view of the aircraft fuselage shell section of FIG. 6 a skin 21 forms a boundary between aircraft cabin air and ambient aircraft air external to the aircraft. The skin 21 has an interior surface 27 on the side of the boundary nearest the aircraft cabin air and an exterior surface 22 on the side of the boundary nearest the ambient aircraft air. The skin 21 has a reinforcing structure 23 connected to the skin 21 and of stringers 24 and frames 25 for reinforcing the skin 21. The reinforcing structure 23 is disposed on the side of the boundary having the ambient aircraft air pressure.

Insulation material 26 is built up onto the reinforcing structure 23. The insulating material 26 is in the form of honeycomb built up onto the reinforcing structure 23 but may be of any suitable open cell structure. The honeycomb insulation material 26 is substantially not load bearing and so an additional load bearing insulation layer 29a is provided as part of a composite second skin 29.

The composite second skin 29 comprises the load bearing insulation layer 29a, a layer of woven fibre 29b made of glass, Kevlar, carbon or like fibres, and an outer gel coat 29c an outer surface of which forms the aerodynamic surface. The composite second skin 29 is thus constructed in a similar manner to boat hulls and can be fuselage sections where the skin 21 and reinforcing structure 23 is of either metal or composite material. The skin 21 and reinforcing structure 23 may be similar to those described with reference to the first embodiment of the present invention. As in the first embodiment, circulating cabin air (as shown by arrow 28) cannot contact regions of the fuselage section at sub-zero temperatures.

If composite materials are used for the skin 21 and reinforcing structure 23 it may be possible to cure the second skin 29 around the skin 21 and reinforcing structure 23, provided they are made of different composite materials that could be cured at different temperatures. For example, the skin 21 and reinforcing structure 23 could be hot cured carbon fibre and then a fibreglass layer 29b could be cold cured onto it.

Where a gel coat 29c is used as the final aerodynamic surface, again similar to boat construction, the gel coat forms a waterproof outer layer and could also contain colouring to provide decorative possibilities for the fuselage shell section, which would save on painting.

Next, a third embodiment of the present invention will be described with reference to FIG. 7 which shows an option of constructing the aircraft fuselage shell section as an integrated exoskeleton of composite material. In the cross-section view of the aircraft fuselage shell section of FIG. 7 a skin 31 forms a boundary between aircraft cabin air and ambient aircraft air external to the aircraft. The skin 31 has an interior surface 37 on the side of the boundary nearest the aircraft cabin air and an exterior surface 32 on the side of the boundary nearest the ambient aircraft air. The skin 31 has a reinforcing structure 33 connected to the skin 31 for reinforcing the skin. The reinforcing structure 33 is disposed on the side of the boundary having the ambient aircraft air pressure.

Unlike the first and second embodiments of the present invention described previously, where the reinforcing structure includes conventional stringers and frames, the reinforcing structure 33 of the third embodiment includes a plurality of “stringers” of structural filler 34a which extend longitudinally along the fuselage section. The long structural fillers 34a are bonded to the skin 31 by a corrugated layer 34b. The corrugated layer 34b is made of carbon or glass fibre, or any other suitable composite material. The long structural fillers 34a are made of balsa, honeycomb, or any other suitable open core structure, or indeed any other suitable material. The reinforcing structure 33 of the third embodiment further includes “frames” constituted by a plurality of spaced bands 35a of composite material which extend circumferentially around the corrugated layer 34b of the fuselage section, like steel bands are wrapped around a wooden barrel. Short structural fillers 35b are disposed between the bands 35a and the corrugated layer 34a for supporting the bands 35a. The short structural fillers 35b are made of balsa, honeycomb, or any other suitable open core structure, or indeed any other suitable material. The spaced composite bands 35a take much of the pressurisation load generated when the aircraft fuselage is pressurised. The composite bands 35a are of carbon or glass fibre or any other suitable composite material.

Between the spaced composite bands 35a and associated short structural fillers 35b insulation material 36 is built up onto the reinforcing structure 33. The insulating material 36 is in the form of honeycomb but may be of any suitable open cell structure. The honeycomb insulation material 36 is preferably load bearing. The insulation material 36 fills in gaps between the spaced bands 35a as well as providing some impact protection to the skin 31 and reinforcing structure 33.

As in the first embodiment of the present invention described previously, in order to provide a smooth aerodynamic surface for the aircraft fuselage, the section of FIG. 7 has a second skin 39, an outer surface of which forms the smooth aerodynamic surface. The insulation material 36 may itself form part of the second skin 39, or a separate second skin 39 may be provided in addition to the insulating material 36 (as shown in FIG. 7). Where a separate second skin is provided, this may be of glass, Kevlar or carbon fibre and may be coated with a gel coat similarly to the second embodiment of the present intention described previously.

The skin 31 and reinforcing structure 33 may be constructed in a single lay-up and cured. An additional layer of carbon, Kevlar or glass fibre could be laid over the reinforcing structure 33 in order to provide greater strength (not shown in FIG. 7) and this would lead to a ‘dimpling’ appearance on the outside of the reinforcing structure 33 before the insulation material 36 is added. In addition, whilst the skin 31 and reinforcing structure 33 are preferably laid-up and cured as one complete section, the second skin 39 and insulation material 36 could be manufactured (namely cured) as two separate pieces and then mated together over the reinforcing structure 33. This would give two seams on the top and bottom of the aircraft, which could be used to give access through the fuselage for antennae, lights and other items that have to be placed on the outside of the fuselage.

As will be appreciated by those skilled in the art, the aircraft fuselage section in accordance with the third embodiment of the present invention may be constructed using metal components where appropriate. For example, the skin 31 and corrugated layer 34b may be of aluminium or titanium. In addition, the corrugated layer may be orientated differently to that described above such that the long structural fillers act as “frames” and run circumferentially around the fuselage section between the skin and the corrugated layer, and the short structural fillers extend between adjacent peaks of the corrugated layer and run longitudinally along the fuselage section. However, manufacturing considerations involved with this orientation of the corrugated layer may prohibit its application.

Whilst the first to third embodiments of the present invention described previously are directed to the first aspect of the present invention where one pressure boundary is defined between a first and a second air pressure, the following embodiments are directed to the second aspect of the present invention where two pressure boundaries are defined for the aircraft fuselage shell section.

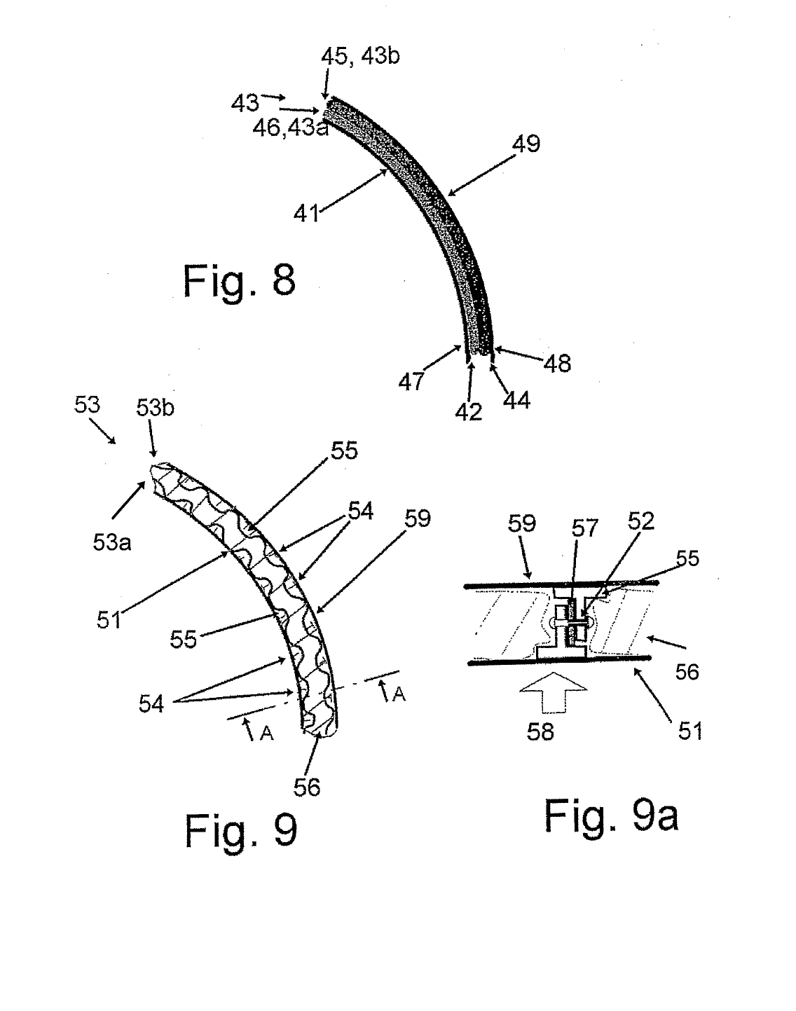

A fourth embodiment of the present invention will be described with reference to FIG. 8 which shows a simple composite sandwich structure. In the cross-section view of FIG. 8 the aircraft fuselage shell section has a first skin 41, a second skin 49, a load bearing insulation layer 46 and a load bearing core layer 45, which may have an open cell structure. The load bearing insulation layer 46 and the load bearing core layer 45 are each disposed between the first skin 41 and the second skin 49. The load bearing insulation layer 46 acts as a first reinforcing structure 43a for the first skin 41 and the load bearing core layer 45 acts as a second reinforcing structure 43b for the second skin 49, allowing the skins 41,49 to be manufactured separately.

The first skin 41 has an interior surface 47 nearest the aircraft cabin air and an exterior surface 42. The load bearing insulation layer 46 is connected to the exterior surface 42 of the first skin 41 and may be air permeable. The second skin 49 has an interior surface 44 and an exterior surface 48 nearest the ambient aircraft air external to the aircraft. The load bearing core layer 45 is connected to the interior surface 44 of the second skin 49. The load bearing insulation layer 46 and the load bearing core layer 45 are connected to each other. During aircraft cruise the aircraft cabin air is likely to be at a considerably higher pressure than the ambient aircraft air.

Since the reinforcing structures 43a, 43b can contain substantial quantities of air, especially when the load bearing core layer 45 has an open cell structure, the region between the first and second skins 41,49 may have an air pressure. In a first example of the fourth embodiment of the present invention, the region between the first and second skins 41,49 is sealed and an air pressure in the region is set between the intended aircraft cabin air pressure and the aircraft ambient air pressure at typical cruise altitude. According to the first example, pressure loading on the aircraft fuselage shell section due to the pressure differential between the aircraft cabin air pressure and the aircraft ambient air pressure is borne by both the first skin 41 and the second skin 49 in a ratio depending on the intermediate air pressure. Such a construction reduces overall pressure loads on the shell section whilst providing some redundancy with respect to containment of the pressure forces.

In a second example of the fourth embodiment of the present invention, the region between the first and second skins 41,49 is actively managed such that the intermediate air pressure is varied according to the pressure forces to be borne by each of the first 41 and second 49 skins, respectively. The active management may be by any known compressor/vacuum means. The intermediate pressure may be managed to optimise the pressure loading on the first and second skins 41,49. Again, such a construction reduces overall pressure loads on the shell section whilst providing some redundancy with respect to containment of the pressure forces.

The skins 41,49 may be made of any suitable material, for example aluminium, titanium, or glass, Kevlar or carbon fibre composites. The load bearing core layer 45 may be in the form of any suitable structure including honeycomb or another open cell structure. The insulation material 46 may be similar to the insulation materials described with reference to the first to third embodiments of the present invention. The second skin 49 may take the form of any of the separate second skins described with reference to the first to third embodiments of the invention.

As will be appreciated by those skilled in the art, the basic construction of the aircraft fuselage shell section of the fourth embodiment of the present invention may be easily adapted in accordance with the first aspect of the present invention where the second skin 49 is not sealed with respect to the aircraft ambient air such that in the region between the first and second skins 41,49 is at the ambient air pressure. In this manner the first skin 41 forms the boundary between the aircraft cabin air pressure and the aircraft ambient air pressure and bears the pressure loading due to any differential between these air pressures.

Next, a fifth embodiment of the present invention will be described with reference to FIG. 9. The fifth embodiment is similar in many respects to the fourth embodiment of the present invention insofar as it relates to the first or second aspects of the present invention. In the cross-section view of FIG. 9 the aircraft fuselage shell section has a first skin 51 and a first reinforcing structure 53a connected to the skin 51 and of stringers 54 and frames 55 for reinforcing the first skin 51. The structure of the first skin 51 and first reinforcing structure 53a is similar to that of the skin 11 and reinforcing structure 13 of the first embodiment of the present invention. The section further comprises a second skin 59 and a second reinforcing structure 53b connected to the second skin 59 and of stringers 54 and frames 55 for reinforcing the second skin 59. The structure of the second skin 59 and second reinforcing structure 53b is similar to that of the first skin 51 and first reinforcing structure 53a. Between the first and second skins 51,59 is disposed insulation material 56 similar to the insulation material 16 of the first embodiment of the present invention.

Once again, similar to the fourth embodiment of the present invention, the pressurisation loads could be shared between the two skins 51,59 and their respective reinforcing structures 53a,53b by adjusting the air pressure between the two skins 51,59. As in the fourth embodiment, the air pressure between the two skins could be equivalent to the ambient aircraft air pressure in which case the fifth embodiment acts in accordance with the first aspect of the present invention, or the air pressure between the two skins can be either actively managed or set at a predetermined pressure such that both skins share the pressure loading in which case the fifth embodiment acts in accordance with the second aspect of the present invention.

The cross section of FIG. 9a is taken along line A-A of FIG. 9 and illustrates how the frames 55 of the first and second reinforcing structures 53a,53b are connected. Rivets 52, or other suitable connections, join the frames 55 together. Insulation material 57 is provided around the rivets 52 to inhibit heat flow through the frame connections. As in the embodiments of the present invention described previously, circulating cabin air 58 is prevented from contacting the aerodynamic surface. The fuselage section of the fifth embodiment of the present invention provides an extremely strong, lightweight structure as well as providing good damage resistance, structural redundancy and flexibility with regard to materials.

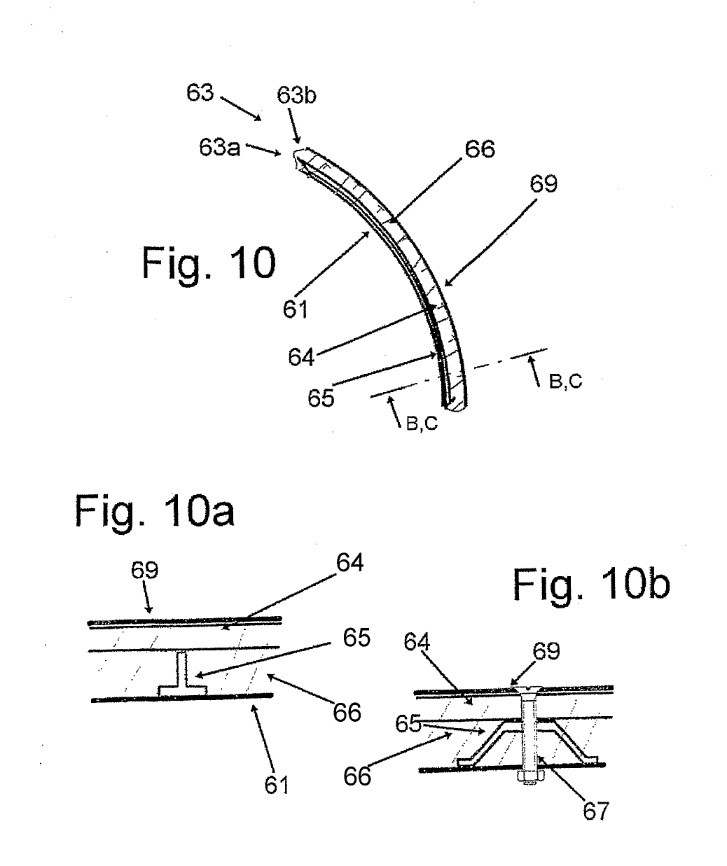

Next, a sixth embodiment of the present invention will be described with reference to FIG. 10. The sixth embodiment relates to the second aspect of the present invention. In the cross-section view of FIG. 10 the aircraft fuselage shell section has a first skin 61 and a second skin 69. Insulation material 66 is disposed between the first and second skins 61,69. The function, materials and structure of the first and second skins 61,69 and of the insulation material 66 is substantially similar to that of the corresponding items described with reference to the fifth embodiment of the present invention.

Whereas in the fifth embodiment the first and second skins have respective reinforcing structures each having stringers and frames, in the sixth embodiment of the present invention the first skin 61 has a first reinforcing structure 63a comprising frames 65, and the second skin 69 has a second reinforcing structure 63b comprising stringers 64. The frames 65 support the first skin 61 and are connected thereto or are integrally formed therewith. The stringers 64 support the second skin 69 and are connected thereto or integrally formed therewith. The skins 61,69 stringers 64 and frames 65 are of suitable materials described previously.

In the sixth embodiment the first skin 61 is adapted to bear the majority of the pressurisation loading, hence frames 65 constitute the first reinforcing structure 63a, and the second skin 69 is adapted to bear the majority of the transverse fuselage loading, especially weight distribution, hence stringers 64 constitute the second reinforcing structure 63b. The aircraft fuselage section according to the sixth embodiment is suitable for use in both the first aspect of the present invention and the second aspect of the present invention where the pressure loading on the first skin 61 is a major part.

The frames 65 may be welded or bonded to the first skin 61 and the stringers 64 riveted onto the second skin 69. Where the stringers 64 and frames 65 touch, some form of attachment is required to transfer load. One possibility for this attachment is shown in FIG. 10a where the frame 65 is bonded to the stringer 64. Alternatively, particularly where greater pressurisation forces are to be borne by the second skin 69, a more secure attachment may be required to prevent separation of the first and second skins 61,69 under pressurised fuselage conditions. One such attachment solution is shown in FIG. 10b where the frames 65 have a “curved top-hat” form and the frames 65 are bolted to the stringers 64 by bolts 67. Such frames 65 may be extruded.

Various combinations and alternatives to the embodiments described above may be readily contemplated by those skilled in the art without departing from the scope of the present invention defined by the appended claims.

In particular, metal layers, such as of aluminium or titanium, may be integrated by an appropriate pattern of welds and joins put in them so that they could be super-plastically formed (or blown) into one piece with the desired cross-section (as is done for many aircraft engine parts).

The skin or skins which bear the fuselage pressurisation loading may be corrugated, which could make it more efficient at withstanding the pressurisation loads (i.e. require a thinner cross-section for a given pressure load). However, there may be no gain overall since a corrugated surface has a greater length by definition.

Where the skin or skins which bear the fuselage pressurisation loading are made of composite materials it may be possible to integrate the keel beam and other internal structures (such as attachment points/structure for overhead luggage bins, floor and cargo bay) therein and fabricate them as a single piece. It may also be possible to build up the supporting structure for any windows and openings in the skin lay-up. In addition, the secondary skin can include a shock-absorbent structure such as Kevlar or Twaron to protect the first skin and reinforcing carbon-fibre or metal structure or structures.

Where two skins share the fuselage pressurisation load such that each skin may be of relatively thin metal sheet material, each sheet may be advantageously “bent” into shape over a former.

The thickness of the aircraft fuselage shell section in accordance with any of the embodiments of the present invention may be adapted such that the thickness of the section varies along the length of the fuselage in such a manner as to reduce transonic drag by area ruling. Either one type of section may be used along the full fuselage length of varying section, or a plurality of different section types may be used to achieve this.

1. An aircraft fuselage shell section for a passenger jet aircraft capable of cruising at an altitude where ambient temperature is about −50° C. and having a pressurized fuselage, the aircraft fuselage shell section comprising:
a skin defining a pressure hull adapted to carry hoop stresses resulting from a substantial pressure differential, between first and second air pressures, generated across the skin when the fuselage is pressurized at cruise altitude such that the second air pressure on the exterior side of the skin is substantially lower than the first air pressure on the interior side of the skin; and
a reinforcing structure including one or more circumferential frame or frame-like members connected to the skin such that hoop stresses in the skin are transferred to circumferential member(s),
wherein the circumferential members(s) are disposed on the exterior side of the skin.

2. An aircraft fuselage section according to claim 1, further comprising a second skin connected to the reinforcing structure and disposed from the skin.

3. An aircraft fuselage section according to claim 2, wherein the second skin constitutes or supports an aerodynamic surface of the section.

4. An aircraft fuselage section according to claim 2, wherein the second skin includes a layer of insulation material.

5. An aircraft fuselage section according to claim 4, wherein the insulation material is adapted to bear substantial load, in use.

6. An aircraft fuselage section according to claim 2, wherein the second skin includes a woven fibre layer.

7. An aircraft fuselage section according to claim 6, wherein the woven fibre layer includes glass, Kevlar® or carbon fibres.

8. An aircraft fuselage section according to claim 3, wherein the second skin includes a gel coat which constitutes the aerodynamic surface.

9. An aircraft fuselage section according to claim 8, wherein the gel coat forms a waterproof outer coating of the section.

10. An aircraft fuselage section according to claim 1, wherein the skin is made of aluminium, titanium, or glass or carbon fibre.

11. An aircraft fuselage section according to claim 1, wherein at least a part of the reinforcing structure is made of aluminium, titanium, or glass or carbon fibre.

12. An aircraft fuselage section according to claim 1, wherein at least a part of the reinforcing structure is riveted, welded or glued to the skin.

13. An aircraft fuselage section according to claim 1, wherein at least a part of the reinforcing structure is integrally formed with the skin.

14. An aircraft fuselage section according to claim 1, further comprising insulation material around the reinforcing structure.

15. An aircraft fuselage section according to claim 14, wherein the insulation is adapted to bear substantial load, in use.

16. An aircraft fuselage section according to claim 14, wherein the insulation has an open cell structure.

17. An aircraft fuselage section according to claim 1, wherein the reinforcing structure includes at least one stringer.

18. An aircraft fuselage section according to claim 2, wherein at least one stringer is attached to the second skin.

19. An aircraft fuselage section according to claim 1, wherein the reinforcing structure further includes a corrugated layer.

20. An aircraft fuselage section according to claim 19, wherein structural filler is disposed at least between the corrugated layer and the skin, the filler acting as a stringer.

21. An aircraft fuselage section according to claim 19, wherein the reinforcing structure further includes a structural layer connected to the corrugated layer.

22. An aircraft fuselage section according to claim 21, wherein structural filler is disposed between the structural layer and the corrugated layer.

23. An aircraft fuselage section according to claim 22, wherein the structural layer is formed as a plurality of spaced bands, forming the frame-like circumferential members.

24. An aircraft fuselage section according to claim 23, wherein insulation material is provided between the spaced bands.

25. An aircraft fuselage section according to claim 1, wherein the reinforcing structure further includes a n insulation layer and a open cell core layer.

26. An aircraft fuselage section according to claim 25, wherein the insulation layer is adapted to bear substantial load, in use.

27. An aircraft fuselage section according to claim 25, wherein the insulation layer is disposed between the open cell core layer and the skin.

28. An aircraft fuselage section according to claim 1, wherein, in use, the first air pressure is an aircraft cabin air pressure and the second air pressure is an ambient altitude air pressure.

29. An aircraft fuselage section according to claim 1, further comprising insulation material on the interior side of the skin

30. An aircraft fuselage section according to claim 1, further comprising voids for accommodating aircraft systems.

31-37. (canceled)
